(19) United States
(12) Patent Application Publication
(10) Pub. No.: US 2012/0170947 A1
(43) Pub. Date: Jul. 5, 2012

(54) APPARATUS AND METHOD FOR RECEIVING LIGHT USING MULTIPLE LIGHT RECEIVING SENSORS

(75) Inventors: Dong Seok KIM, Incheon (KR); Dae Gak KIM, Seoul (KR); Eun Hee KIM, Seoul (KR); So Hyun LEE, Seoul (KR); Jae Hwan LEE, Seoul (KR); Hong Min CHOI, Seoul (KR)

(73) Assignee: PANTECH CO., LTD., Seoul (KR)

(21) Appl. No.: 13/225,704

(22) Filed: Sep. 6, 2011

(30) Foreign Application Priority Data
Dec. 30, 2010 (KR) 10-2010-0138646

(51) Int. Cl. H04B 10/06

(52) U.S. Cl. 398/202

(57) ABSTRACT

In an apparatus and method for receiving light using multiple light receiving sensors, a light receiving apparatus includes a light receiving unit comprising multiple light receiving sensors to receive an optical signal; an analyzing unit to extract a highlighted area; a light receiving controlling unit to activate a first light receiving sensor corresponding to the highlighted area, and to determine the first light receiving sensor to be a part of a first sensor group; and a data processing unit to demodulate an optical signal received by the first sensor group into data. A method for receiving an optical signal including extracting a highlighted area; activating a light receiving sensor corresponding to the highlighted area; receiving light through the first light receiving sensor; grouping the first light receiving sensor into a first sensor group; and demodulating an optical signal received by the first sensor group into data.

### CROSS-REFERENCE TO RELATED APPLICATION

This application claims priority from and the benefit under 35 U.S.C. §119(a) of Korean Patent Application No. 10-2010-0138646, filed on Dec. 30, 2010, which is incorporated by reference for all purposes as if fully set forth herein.

### BACKGROUND

1. Field

The present disclosure relates to an apparatus and a method for receiving light using light receiving sensors.

2. Discussion of the Background

As luminous efficiency of a Light Emitting Diode (LED) has improved and the price of the LED has fallen, the LED has become more common in market places for a lighting such as a portable device, a display, an automobile, a traffic light, and a billboard, and in market places for a general purpose lighting, such as a fluorescent lamp, and an incandescent lamp. Further, due to various reasons, such as depletion of available Radio Frequency (RF) band resources, increased possibility of interference among many wireless communication technologies, an increasing demand for a communication security and the introduction of a broadband-ubiquitous communication environment of fourth generation (4G) wireless technology, and the like, an interest for an optical wireless technology has increased.

Visible Light Communication (VLC) refers to a communication technology that transmits information using visible light. In the VLC technology, data may be transmitted by controlling an emission of visible light emitted from a device having a light emitting device, such as an LED, and the like. The VLC may not need an allocated frequency, and may enable a rapid transmission of a large amount of data using a rapid flicker.

In the VLC technology, since propagation direction of light is visible, a reception range of information may be more accurately estimated than that of other wireless communication technologies. The VLC technology may be more reliable in the aspects of security and low-power consumption. Accordingly, the VLC technology may be applicable to a hospital and an airplane where the RF communication is partially or wholly restricted.

The VLC technology may be appropriate for one-on-one communication based on a single physical channel. However, in a communication environment where there are many receiving units, or where multiple channels are used, a single-channel based VLC technology may be deficient.

### SUMMARY

Exemplary embodiments of the present invention provide a light receiving apparatus including multiple light receiving sensors, and an optical signal receiving method for receiving light using multiple light receiving sensors.

Additional features of the invention will be set forth in the description which follows, and in part will be apparent from the description, or may be learned by practice of the invention.

An exemplary embodiment of the present invention discloses a light receiving apparatus including a light receiving unit comprising multiple light receiving sensors to receive an optical signal; an image analyzing unit to extract a highlighted area; a light receiving controlling unit to activate a first light receiving sensor corresponding to the highlighted area and a second light receiving sensor corresponding to the highlighted area, and to group the first light receiving sensor and the second light receiving sensor into a first sensor group; and a data processing unit to demodulate an optical signal received by the first sensor group into data.

An exemplary embodiment of the present invention also discloses a method for receiving an optical signal including extracting a highlighted area; activating a first light receiving sensor corresponding to the highlighted area and a second light receiving sensor corresponding to the highlighted area; receiving light through the first light receiving sensor and the second light receiving sensor; grouping the first light receiving sensor and the second light receiving sensor into a first sensor group; and demodulating an optical signal received by the first sensor group into data.

An exemplary embodiment of the present invention also discloses a light receiving apparatus including a light receiving unit comprising multiple light receiving sensors to receive an optical signal; an analyzing unit to extract a highlighted area; a light receiving controlling unit to activate a first light receiving sensor corresponding to the highlighted area, and to determine the first light receiving sensor to be a part of a first sensor group; and a data processing unit to demodulate an optical signal received by the first sensor group into data.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a light receiving apparatus to receive an optical signal according to an exemplary embodiment of the present invention.

FIG. 2 is a diagram illustrating an arrangement of an image sensor and a light receiving unit according to an exemplary embodiment of the present invention.

FIG. 3 is a diagram illustrating activated light receiving sensors if an optical signal is received from a single light source according to an exemplary embodiment of the present invention.

FIG. 4 is a diagram illustrating activated light receiving sensors if an optical signal is received from three light sources according to an exemplary embodiment of the present invention.

FIG. 5 is a flowchart illustrating a method for receiving an optical signal according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth herein. Rather, these exemplary embodiments are provided so that the present disclosure is thorough, and will fully convey the scope of the invention to those skilled in the art.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Exemplary embodiments of the present invention provide a method for receiving an optical signal using selected sensors among multiple light receiving sensors in a light receiving apparatus.

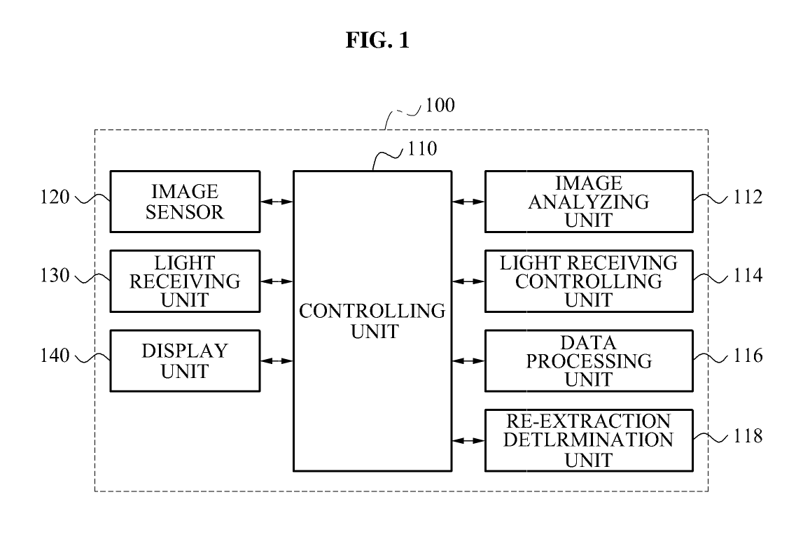

FIG. 1 is a diagram illustrating a light receiving apparatus to receive an optical signal according to an exemplary embodiment of the present invention.

As shown in FIG. 1, the light receiving apparatus 100 may include a controlling unit 110, an image sensor 120, a light receiving unit 130, a display unit 140, an image analyzing unit 112, a light receiving controlling unit 114, a data processing unit 116, and a re-extraction determination unit 118.

The image sensor 120 may capture an image by converting an optical image received through a lens into an electrical signal. The image sensor 120 may include a charge coupled device (CCD) or a complementary metal-oxide-semiconductor (CMOS) active pixel sensor.

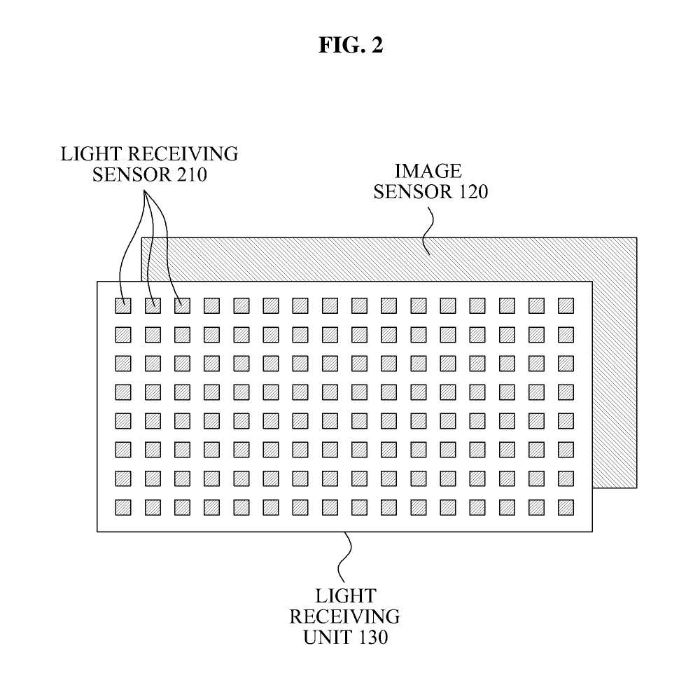

The light receiving unit 130 may include multiple light receiving sensors to convert received visible light into an electrical signal. Each of the multiple light receiving sensors may correspond to an area of the image sensor 120. The number of the light receiving sensors included in the light receiving unit 130 may correspond to the number of pixels of the image sensor 120 as illustrated in FIG. 2. Further, the image sensor 120 may be divided into multiple areas which include a certain number of pixels. For example, each of the light receiving sensors may respectively correspond to each of the multiple areas. The light receiving unit 130 may include a photo diode (PD).

The image sensor 120 and the light receiving unit 130 may be arranged as illustrated in FIG. 2.

FIG. 2 is a diagram illustrating an arrangement of an image sensor and a light receiving unit according to an exemplary embodiment of the present invention.

Referring to FIG. 2, the light receiving unit 130 may be located in front of the image sensor 120, i.e., the light receiving unit 130 may be located between a light source and the image sensor 120. Further, the light receiving unit 130 may include multiple light receiving sensors 210 corresponding to each pixel of the image sensor 120. In an example, the light receiving unit 130 may be configured by matching two or more adjacent pixels of the image sensor 120 with a single light receiving sensor 210.

The display unit 140 may display status information or an indicator, numbers and letters, a moving picture and a still picture, and the like that may be generated during an operation of the light receiving apparatus 100. Further, the display unit 140 may display an image received through the image sensor 120, and may display a captured image by marking a highlighted area acquired by the image analyzing unit 112, or by marking each area of groups of light receiving sensors on the captured image. The groups of the light receiving sensors may be identified by the light receiving controlling unit 114.

The image analyzing unit 112 may extract a highlighted area from the captured image. The image analyzing unit 112 may extract an area where brightness of received light is greater than a determined brightness value as the highlighted area. Further, the image analyzing unit 112 may extract an area where the brightness of the light is greater than a reference value as the highlighted area. In an example, the reference value may be an average value of brightness of the captured images, or an intermediate value of brightness of the captured image. The captured image may be a preview image received through the image sensor 120. The image analyzing unit 112 may extract an area where brightness of a pixel of the image is greater than a determined brightness value or a reference value as a part of the highlighted area.

The image analyzing unit 112 may display the captured image by distinguishing the highlighted area from the captured image when the captured image is displayed by the display unit 140.

The light receiving controlling unit 114 may activate the light receiving sensors corresponding to the highlighted area extracted by the image analyzing unit 112. The light receiving controlling unit 114 may group the activated light receiving sensors. The light receiving controlling unit 114 may group the light receiving sensors based on whether the activated light receiving sensors are adjacent to one another. Adjacent sensors may be grouped, and multiple adjacent light receiving sensors may be included in a group. That is, the light receiving controlling unit 114 may separately group the light receiving sensors for each highlighted area.

The light receiving controlling unit 114 may group the activated light receiving sensors based on a frequency difference (or a wavelength) of an optical signal received through the activated light receiving sensors. Here, a frequency of an optical signal may be a main frequency of the optical signal. The main frequency of the optical signal may be the frequency of a light wave having highest signal strength among light waves of the optical signal. The activated light receiving sensors may be grouped into multiple groups based on the frequency difference, if the frequencies of optical signals received by the activated light receiving sensors are not equal. In an example, if two light sources are adjacent to each other, a highlighted area generated by the two light sources may be grouped according to different frequencies of the two light sources. That is, if the light receiving controlling unit 114 groups the light receiving sensors based on the frequency of the optical signal, different light sources may be distinguished from the highlighted area generated by two adjacent light sources.

The light receiving controlling unit 114 may display the captured image by marking each area of grouped light receiving sensors to be distinguished from the captured image if the captured image is displayed by the display unit 140. Hereinafter, the grouped light receiving sensors may be referred to as a sensor group. The sensor group may be divided into smaller groups, such as sensor subgroups.

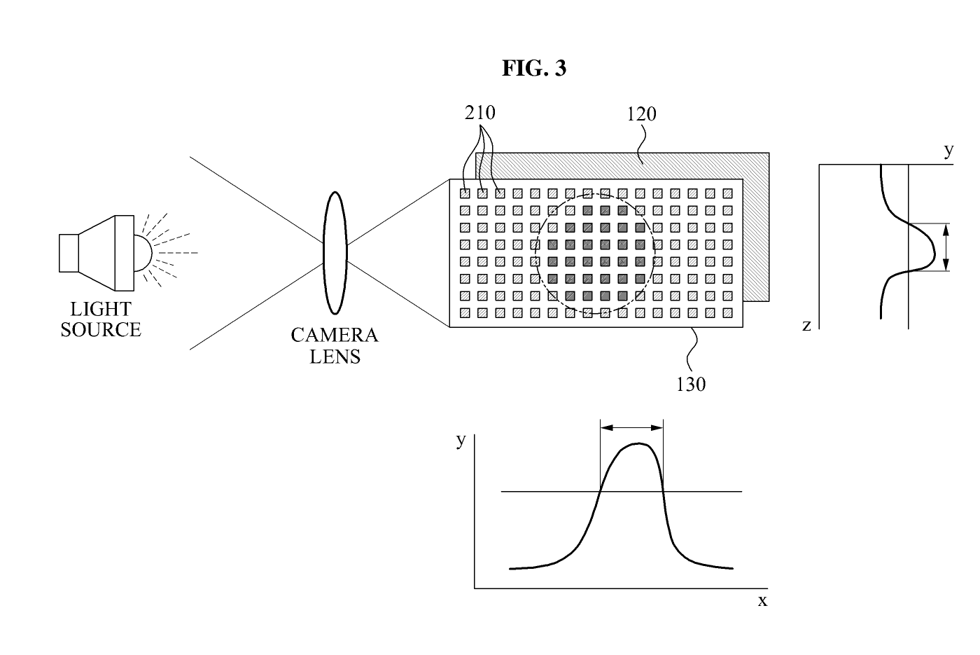

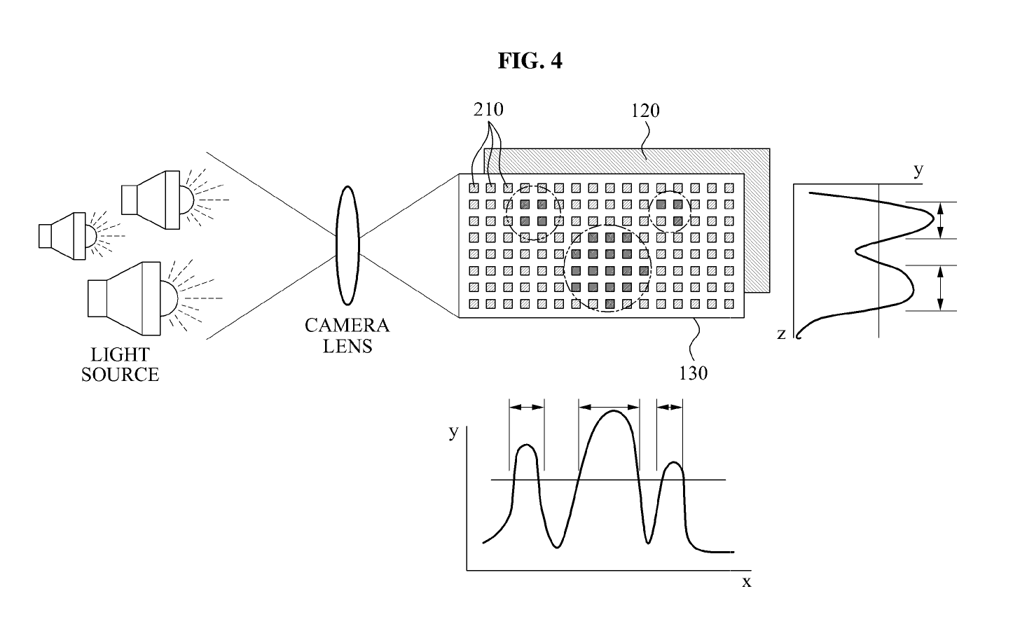

Examples of the light receiving sensors to extract the highlighted area using the image analyzing unit 112 according to the number of light sources and to be activated by the light receiving controlling unit 114 will be further described with reference to FIG. 3 and FIG. 4.

FIG. 3 is a diagram illustrating activated light receiving sensors if an optical signal is received from a single light source according to an exemplary embodiment of the present invention.

Referring to FIG. 3, if light is received from a single light source, a single area brighter than a determined brightness value may be identified in each direction of horizontal pixels and vertical pixels as illustrated in graphs by measuring brightness values of the horizontal pixels and the vertical pixels of the image sensor 120. In FIG. 3, the y axis indicates a brightness value, and the x axis indicates pixels corresponding to a row of the image sensor 120, and the z axis indicates pixels corresponding to a column of the image sensor 120.

According to a result of a measurement of the image sensor 120, a pixel brighter than the determined brightness value may be determined as a part of a highlighted area. That is, if there is a single light source, there may be one highlighted area. Then, the light receiving controlling unit 114 may activate certain light receiving sensors of the light receiving unit 130 corresponding to the highlighted area. In FIG. 3, activated light receiving sensors are indicated to be darker than inactivated light receiving sensors.

FIG. 4 is a diagram illustrating activated light receiving sensors if an optical signal is received from three light sources according to an exemplary embodiment of the present invention.

Referring to FIG. 4, if light is received from multiple light sources, multiple areas brighter than a determined brightness value may be identified in each direction of horizontal pixels and vertical pixels as illustrated in graphs by measuring brightness values of the horizontal pixels and the vertical pixels of the image sensor 120. In FIG. 4, the y axis indicates a brightness value, and the x axis indicates pixels corresponding to a row of the image sensor 120, and the z axis indicates pixels corresponding to a column of the image sensor 120.

According to the result of a measurement of the image sensor 120, a pixel brighter than the determined brightness value may be determined as a part of a highlighted area. If multiple pixels are determined to be brighter that the determined brightness value, adjacent pixels among the multiple pixels may be grouped into a highlighted area. That is, when there are multiple light sources, there may be multiple highlighted areas. However, if two light sources are adjacent to each other, there may be one highlighted area because all of the pixels brighter than the determined brightness value may not be divided into separate regions. In this instance, the one highlighted area may be grouped into two groups by distinguishing the frequency difference or the wavelength difference of the two light sources. Then, the light receiving controlling unit 114 may activate the light receiving sensors of the light receiving unit 130 corresponding to the multiple highlighted areas. In FIG. 4, activated light receiving sensors are indicated to be darker than inactivated light receiving sensors. The light receiving controlling unit 114 may activate the light receiving sensors of the light receiving unit 130 corresponding to a group distinguished by the frequency difference or the wavelength difference.

The data processing unit 116 may demodulate an optical signal into data by each group of the grouped light receiving sensors. That is, the data processing unit 116 may demodulate each optical signal received by grouped light receiving sensors 210 into data.

The re-extraction determination unit 118 may control the image analyzing unit 112 to perform re-extraction of a highlighted area at a time interval. The re-extraction determination unit 118 may control the image analyzing unit 112 to perform re-extraction of a highlighted area if a motion greater than a determined motion value is detected. The motion may be a motion of an optical communication apparatus or a motion of the light receiving apparatus 100.

The controlling unit 110 may control overall operation of the light receiving apparatus 100. The controlling unit 110 may perform a portion of or all the operations of the image analyzing unit 112, the light receiving controlling unit 114, the data processing unit 116, and the re-extraction determination unit 118. The controlling unit 110, the image analyzing unit 112, the light receiving controlling unit 114, the data processing unit 116, and the re-extraction determination unit 118 are separately illustrated in order to describe each of the operations separately. Thus, the controlling unit 110 may include one or more processors to perform one or more of the operations of the image analyzing unit 112, the light receiving controlling unit 114, the data processing unit 116, and the re-extraction determination unit 118. The controlling unit 110 may include one or more processors to perform a portion of the operations of the image analyzing unit 112, the light receiving controlling unit 114, the data processing unit 116, and the re-extraction determination unit 118.

A method for receiving an optical signal in a light receiving apparatus having multiple light receiving sensors will be described hereinafter with reference to the accompanying drawings.

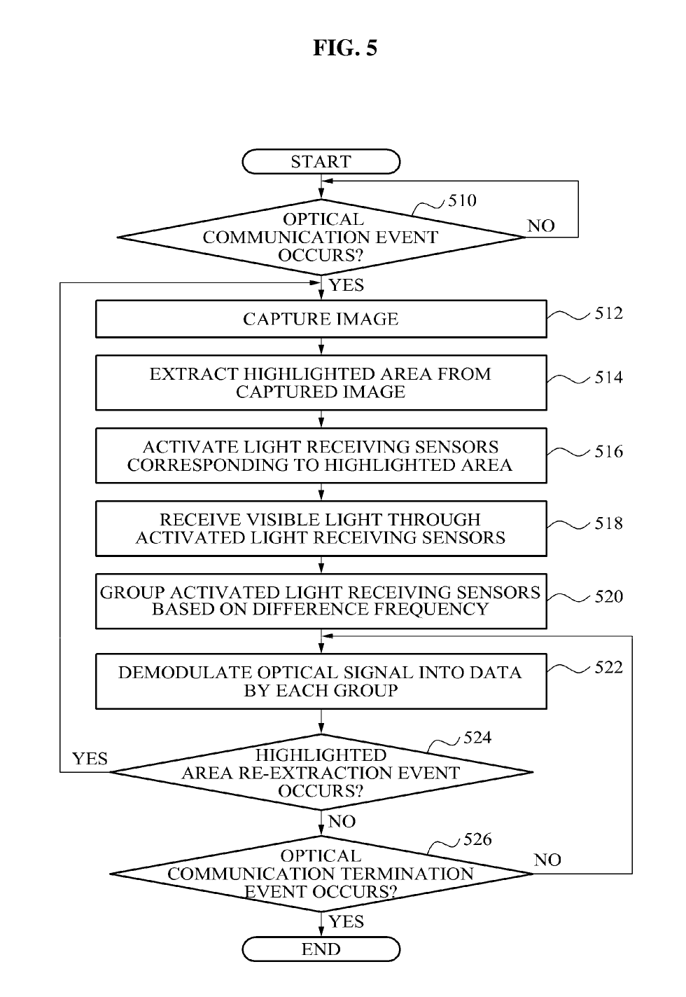

FIG. 5 is a flowchart illustrating a method for receiving an optical signal according to an exemplary embodiment of the present invention.

Referring to FIG. 5, if an optical communication event occurs to initiate an optical communication in operation 510, the light receiving apparatus may capture an image in operation 512. The image may be captured prior to receiving an optical signal. The optical communication event may be an optical signal reception event determined by the light receiving apparatus. The optical signal reception event may be determined if the light receiving apparatus receives an optical signal which contains a protocol or a preamble for communication.

In operation 514, the light receiving apparatus may extract a highlighted area where brightness of received light is greater than a determined brightness value from the captured image. The captured image may include a preview image received through an image sensor.

In operation 516, the light receiving apparatus may identify light receiving sensors corresponding to the highlighted area, and activate the identified light receiving sensors.

In operation 518, the light receiving apparatus may receive visible light through the activated light receiving sensors. In operation 520, the light receiving apparatus may group the activated light receiving sensors into multiple groups based on a frequency difference by identifying the frequency of the received visible light.

In operation 522, the light receiving apparatus may demodulate an optical signal into data by each group of the grouped light receiving sensors.

In operation 524, the light receiving apparatus may determine whether a highlighted area re-extraction event occurs. The highlighted area re-extraction event may occur at a determined time interval. The highlighted area re-extraction event may occur if a motion greater than a determined motion value is detected by detecting a motion of an optical communication apparatus or a motion of the light receiving apparatus.

If the highlighted area re-extraction event occurs, the light receiving apparatus may return to operation 512, and may perform a process of re-extraction of a highlighted area.

If it is determined that the highlighted area re-extraction event does not occur, the light receiving apparatus may determine whether an optical communication termination event occurs in operation 526.

If it is determined that an optical communication termination event does not occur, the light receiving apparatus may return to operation 522, and may demodulate the optical signal to data.

If the optical communication termination event occurs, the light receiving apparatus may terminate the process.

According to aspects of the invention, a light receiving sensor 210 may receive optical signals having different frequencies. The light receiving sensor 210 may be determined to correspond to one or multiple light sources and/or one or multiple groups.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

Exemplary embodiments of the present invention provide a light receiving apparatus and a method for receiving an optical signal from multiple light sources. Certain light receiving sensors among multiple light receiving sensors may be activated and may be grouped into a grouped light receiving sensors. Thus, optical signals transmitted from multiple light sources may be selectively received by the grouped light receiving sensors and be used for visible light communication.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light receiving apparatus, comprising:
a light receiving unit comprising multiple light receiving sensors to receive an optical signal;
an image analyzing unit to extract a highlighted area;
a light receiving controlling unit to activate a first light receiving sensor corresponding to the highlighted area and a second light receiving sensor corresponding to the highlighted area, and to group the first light receiving sensor and the second light receiving sensor into a first sensor group; and
a data processing unit to demodulate an optical signal received by the first sensor group into data.

2. The apparatus of claim 1, wherein the highlighted area is an area where brightness of received light is greater than a determined brightness value or a reference value.

3. The apparatus of claim 1, further comprising:
an image sensor to capture an image,
wherein the image analyzing unit distinguishes the highlighted area from the image.

4. The apparatus of claim 1, further comprising a display unit to display an image,
wherein the light receiving controlling unit controls the display unit to display an image by indicating an area corresponding to the first sensor group to be distinguished from the image or by indicating the highlighted area to be distinguished from the image.

5. The apparatus of claim 1, wherein the light receiving controlling unit groups the first sensor group into a first sensor subgroup and a second sensor subgroup based on a frequency difference of the optical signal received by the first sensor group.

6. The apparatus of claim 1, wherein the light receiving controlling unit groups the first light receiving sensor and the second light receiving sensor into the first sensor group if the first light receiving sensor and the second light receiving sensor are located adjacent to one another.

7. The apparatus of claim 1, further comprising a re-extraction determination unit to determine re-extraction of the highlighted area of the image analyzing unit at a determined time interval.

8. The apparatus of claim 1, further comprising a re-extraction determination unit to determine re-extraction of the highlighted area of the image analyzing unit if a motion of the light receiving apparatus is greater than a determined motion value.

9. The apparatus of claim 3, wherein the highlighted area is distinguished from the image by comparing brightness of a pixel of the image with a determined brightness value or a reference value.

10. A method for receiving an optical signal, the method comprising:
capturing an image;
extracting a highlighted area from the captured image;
activating a first light receiving sensor corresponding to the highlighted area and a second light receiving sensor corresponding to the highlighted area;
receiving light through the first light receiving sensor and the second light receiving sensor;
grouping the first light receiving sensor and the second light receiving sensor into a first sensor group; and
demodulating an optical signal received by the first sensor group into data.

11. The method of claim 10, further comprising:
comparing brightness of the light with a determined brightness value or a reference value; and
determining an area corresponding to the first light receiving sensor as a part of the highlighted area if the brightness of the light is greater than the determined brightness value or the reference value.

12. The method of claim 10, further comprising:
grouping the first sensor group into a first sensor subgroup and a second sensor subgroup based on a frequency difference of the optical signal received by the first sensor group.

13. The method of claim 10, wherein the grouping of the first light receiving sensor and the second light receiving sensor into the first sensor group is performed if the first light receiving sensor and the second light receiving sensor are located adjacent to one another.

14. The method of claim 10, further comprising:
determining whether to re-extract a highlighted area;
re-extracting the extracted highlighted area;
activating a third light receiving sensor corresponding to the re-extracted highlighted area;
deactivating the first light receiving sensor not corresponding to the re-extracted highlighted area;
re-grouping the third light receiving sensor and the second light receiving sensor corresponding to the re-extracted highlighted area.

15. The method of claim 14, further comprising:
comparing a motion of a light receiving apparatus with a determined motion value; and
determining re-extraction of a highlighted area if the motion of the light receiving apparatus is greater than the determined motion value.

16. The method of claim 10, further comprising:
capturing an image;
displaying the image by indicating the highlight area on the image or by indicating corresponding area of the first sensor group on the image.

17. The method of claim 16, wherein the highlighted area is extracted from the image by comparing a brightness of a pixel of the image with a determined brightness value or a reference value.

18. The method of claim 10, further comprising:
extracting a second highlighted area;
activating a fourth light receiving sensor corresponding to the second highlighted area and a fifth light receiving sensor corresponding to the second highlighted area;
receiving light through the fourth light receiving sensor and the fifth light receiving sensor;
grouping the fourth light receiving sensor and the fifth light receiving sensor into a second sensor group; and
demodulating an optical signal received by the second sensor group into second data.

19. A light receiving apparatus, comprising:
a light receiving unit comprising multiple light receiving sensors to receive an optical signal;
an analyzing unit to extract a highlighted area;
a light receiving controlling unit to activate a first light receiving sensor corresponding to the highlighted area, and to determine the first light receiving sensor to be a part of a first sensor group; and
a data processing unit to demodulate an optical signal received by the first sensor group into data.

20. The apparatus of claim 19, further comprising:
an image sensor to capture an image;
a display unit to display the image; and
a re-extraction determination unit to determine re-extraction of the highlighted area of the image analyzing unit,
wherein the highlighted area is an area where brightness of a pixel of the image is greater than a determined brightness value or a reference value.
